(19) United States
(12) Patent Application Publication
(10) Pub. No.: US 2016/0314695 A1
(43) Pub. Date: Oct. 27, 2016

(54) Collaborative Prayer Method and System

(71) Applicant: Faiyaz Haider, Centreville, VA (US)

(72) Inventor: Faiyaz Haider, Centreville, VA (US)

(21) Appl. No.: 14/693,387

(22) Filed: Apr. 22, 2015

(51) Int. Cl. G09B 5/02; G09B 19/00

(52) U.S. Cl. CPC G09B 5/02; G09B 19/00

(57) ABSTRACT

A method for conducting prayers using a mobile device includes presenting an interface enabling the user to designate a specific prayer or select from a stored prayer. An interface is presented enabling the user to select a number of prayer times that the designated prayer will be recited. An interface is presented enabling the user to initiate contact with one or more individuals using the user's contacts or the user's social media account in order to invite the one or more individuals to join a prayer group for the designated prayer. An interface is presented enabling the user initiate the prayer for the prayer group. An interface is presented enabling the user to count the number of times that the user has recited the designated prayer. An interface is presented enabling the user to donate from a pre-determined list of denominations using an electronic payment account of the user.

### CROSS-REFERENCE TO RELATED APPLICATIONS

None.

### STATEMENT REGARDING FEDERALLY SPONSORED RESEARCH

Not applicable.

### BACKGROUND

The present disclosure relates to collaborative prayer by remotely located individuals and more particularly to a method and system to conveniently and simultaneously connect such remotely located individuals for collective and collaborative praying.

It is common for individuals of a religious community to collectively pray together in person. It is difficult at best to create such in person community prayer experience when individuals are scattered in different locations, be it different cities, different states, or even different countries. Yet, there remains a desire to be able to do just that.

Heretofore, various attempts to connect remotely located individuals together for prayer have been made. For example, U.S. Patent Publication No. 2010/0003654 discloses a prayer box (electronic storage device) that could be used in the home, but may also be useful at special occasions, holidays, and events where a prayer or invocation is required/needed/requested. U.S. Pat. No. 8,862,678 discloses a network of connected devices, such as mobile devices, to coordinate times for specific media messages/programs (including prayer) to be streamed to other application users. U.S. Patent Publication 2003/0182371 discloses a collaborative-networked communication system. The purpose of this system is for members of a community to provide self-support or encouragement to other members of the community.

### BRIEF SUMMARY

Disclosed is a method for conducting prayers using a mobile device. The method includes presenting an interface enabling the user to designate a specific prayer or select from a stored prayer. An interface is presented enabling the user to select a number of prayer times that the designated prayer will be recited. An interface is presented enabling the user to initiate contact with one or more individuals using the user's contacts or the user's social media account in order to invite the one or more individuals to join a prayer group for the designated prayer. An interface is presented enabling the user initiate the prayer for the prayer group. An interface is presented enabling the user to count the number of times that the user has recited the designated prayer. An interface is presented enabling the user to donate from a pre-determined list of denominations using an electronic payment account of the user. Included in the designated prayers are the Quranic prayers.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is a flow diagram of a mobile application commencing with its launch;

FIG. 2 is a flow diagram of the mobile application sub module for connecting with the user's Facebook® account;

FIG. 3 is a flow diagram of the mobile application sub module for connecting with the user's Twitter® account;

FIG. 4 is a flow diagram of the mobile application where the user signs up;

FIG. 5 is a flow diagram of the mobile application where the user signs in to his/her account;

FIG. 6 is a flow diagram of the mobile application where the user takes a tour of the application;

FIG. 7 is a flow diagram of the mobile application where the user enters his/her profile;

FIGS. 8A and 8B are a flow diagram of the mobile application where the user accesses a prayer group;

FIG. 9 is a flow diagram of the mobile application for the Tasbeeh or Rosary;

FIGS. 10A and 10B is a flow diagram of the mobile application where the user can donate money;

FIG. 11 is the splash or opening screen of the mobile application;

FIG. 12 is the screen where the user can sign up, sign in, take a tour or connect via social media;

FIG. 13 is the sign up screen;

FIG. 14 is the screen for terms and conditions;

FIG. 15 is the privacy policy screen;

FIG. 16 is the screen for the user to initiate a prayer group;

FIG. 17 is the screen for the user to create a main prayer;

FIG. 18 is the screen for the user to create a final prayer;

FIG. 19 is the screen for the user to select his/her prayer beans;

FIG. 20 is the screen for the user to invite others to a prayer group from his/her contacts;

FIG. 21 is the screen for the user to invite others to a prayer group from his/her emails list;

FIG. 22 is the screen for the user to set the time for an active prayer to occur;

FIG. 23 is the screen for the user to accept or reject a prayer invitation;

FIG. 24 is the screen listing the details of the accepted prayer invitation;

FIG. 25 is the screen where the user can initiate or start the accepted prayer with the first prayer being listed;

FIG. 26 is the screen shot listing the members of the prayer group;

FIG. 27 is the screen where the user can take a photo (“selfie”) for display to the prayer group members;

FIG. 28 is the screen show showing the counter of prayers completed;

FIG. 29 is the screen where the user can archive prayer groups, prayers, prayer beans, etc.;

FIG. 30 is the screen where the user designates a donation denomination;

FIG. 31 is the screen for “How it Works”;

FIG. 32 is the screen of instructions;

FIG. 33 is a screen describing the “About” the application;

FIG. 34 is the main screen; and

FIG. 35 is the screen where the user can edit the user's account details.

The drawings will be described in greater detail below.

### DETAILED DESCRIPTION

The disclosure will be illustrated with specific reference to Muslim prayers; although, it will be recognized that prayers and prayer groups for other religions could equally be the subject of the disclosure. The disclosed application or app fully replicates the experience of an in person collaborative prayer, such as, for example, the “Ayat-e-Kareema” prayer carried out in gatherings. The app leverages the user's social media accounts, such as, for example, Facebook® and Twitter®, as well as the user's contact list for email prayer invitations or input of a specific email address.

The three main sections of the application are “Prayer Groups” for initiating, monitoring active invitations and on-going prayers, and archival prayer information. Another main section is the integrated “Tasbeeh” (or Rosary), which can be recited at any time with the assurance that the count will stay intact. The number of recitations can be incremented each time the prayer is recited, decremented when a mistake is made during a prayer, or resent. The next main section is the “Donate” section where the user can donate from a list of pre-selected denominations via a credit card of PayPal® account.

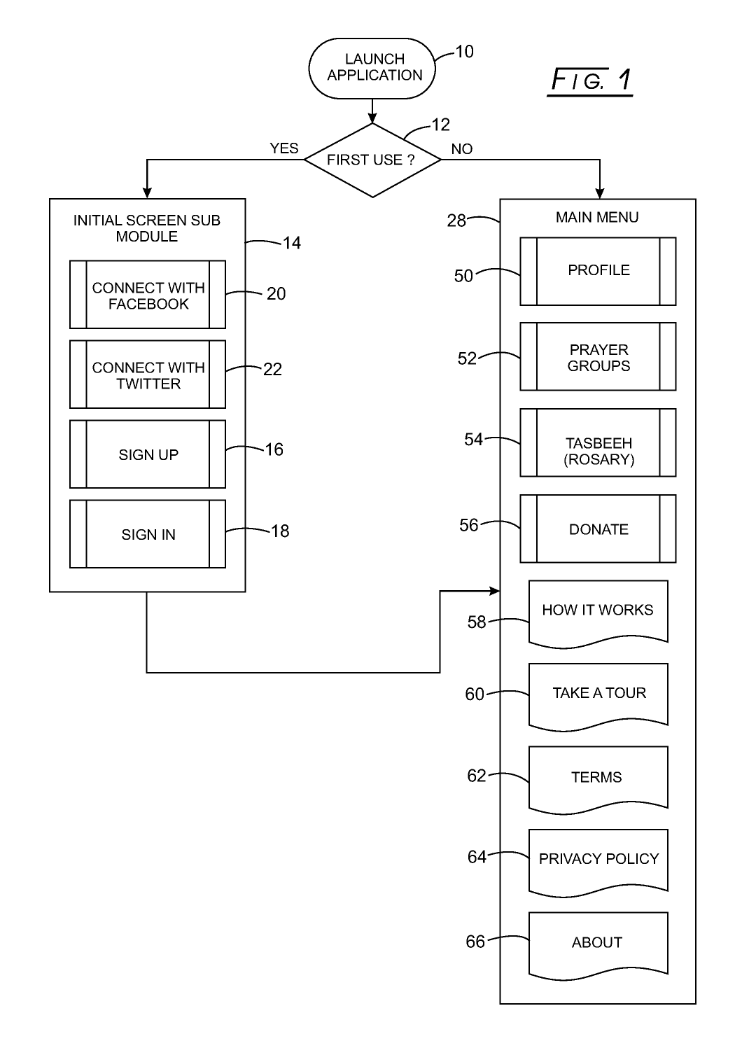

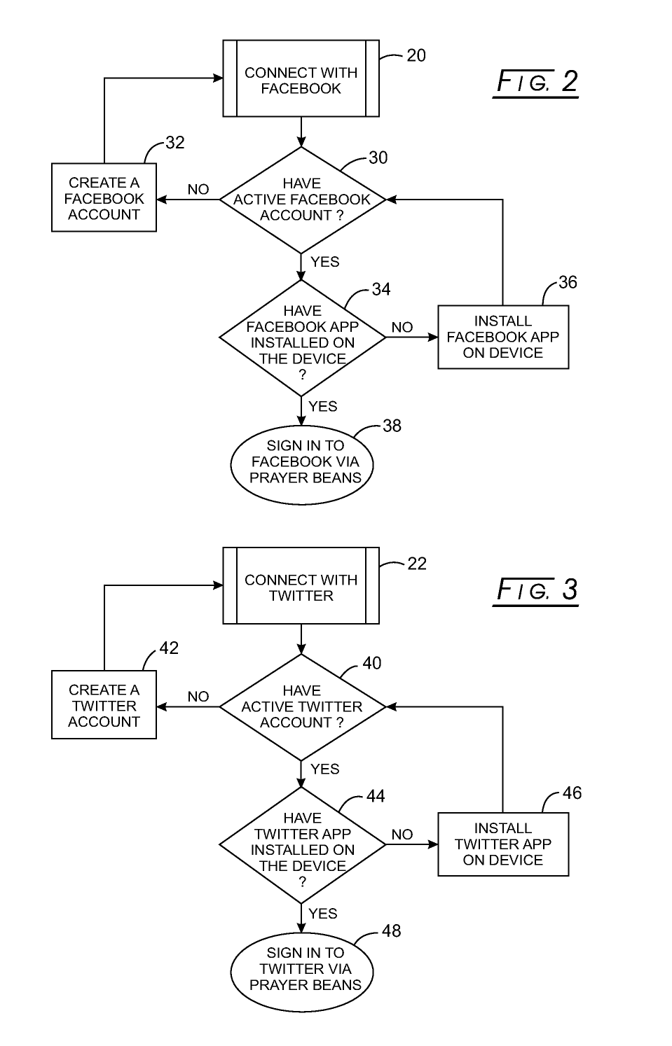

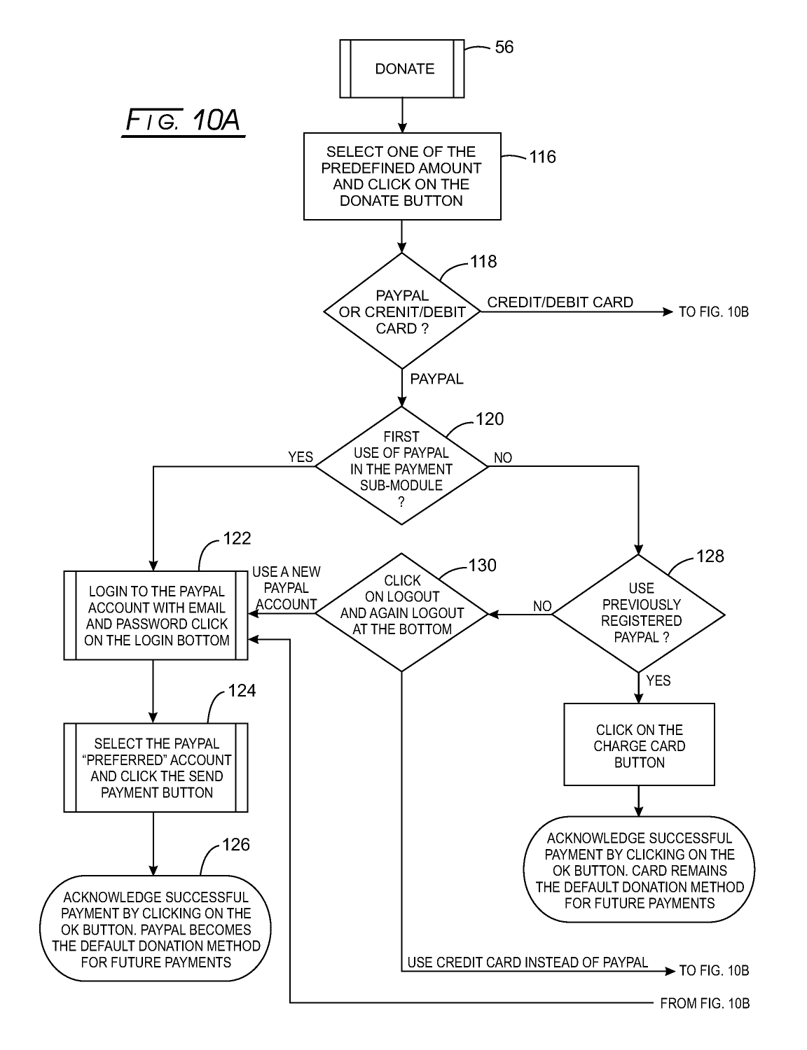

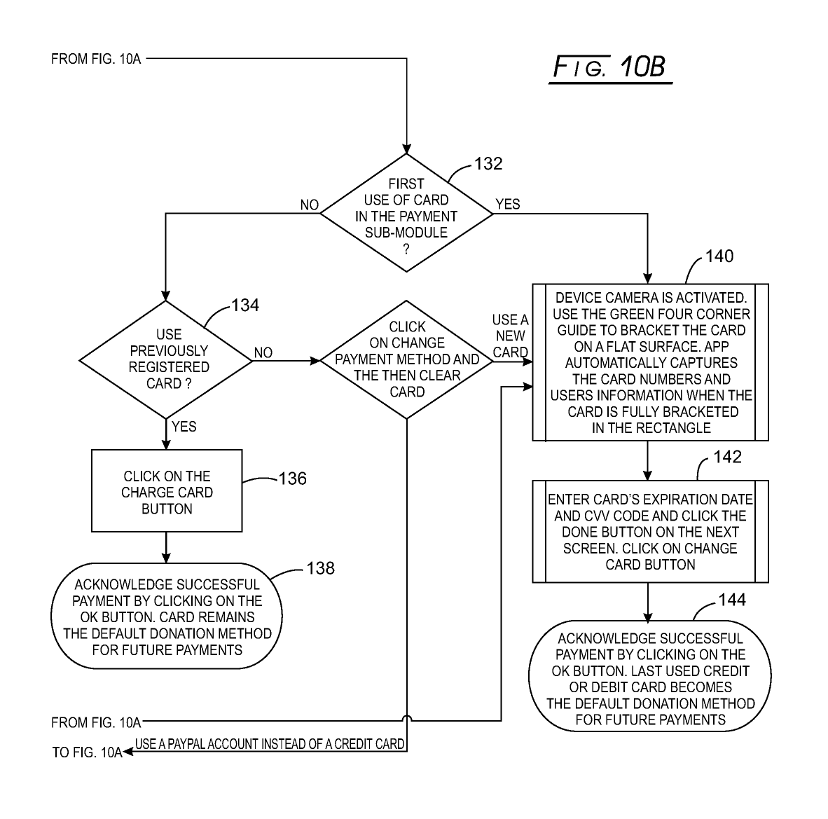

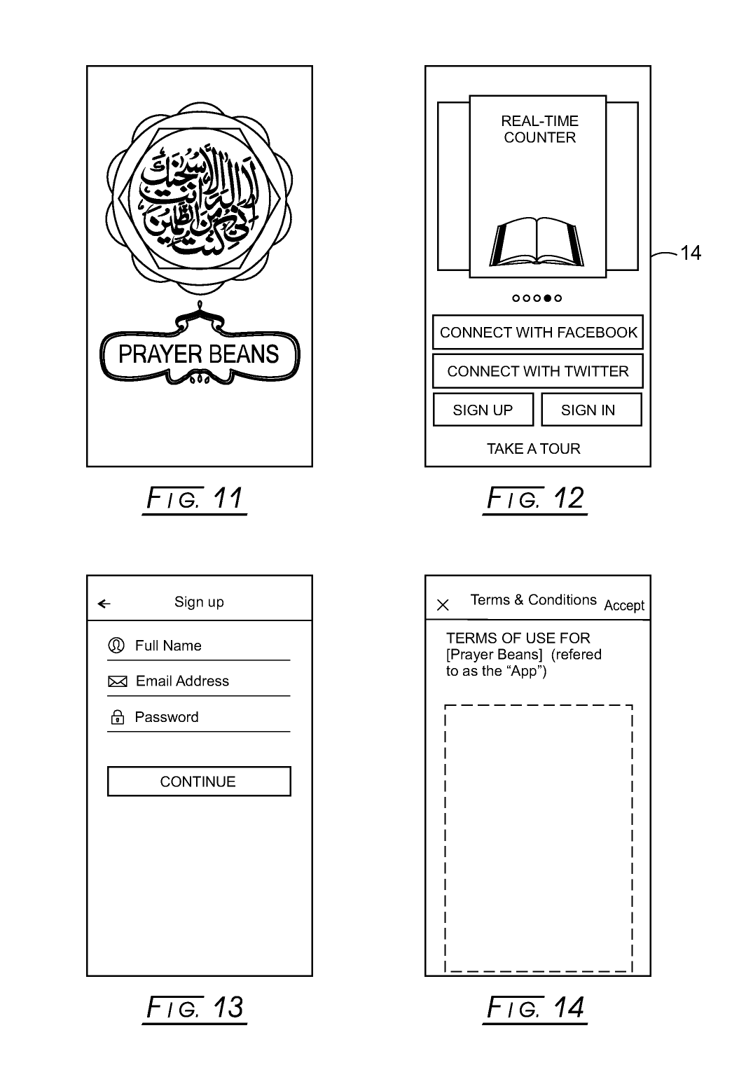

FIGS. 1-10 are the flow diagrams for the application; while FIGS. 11-35 are the wireframe or screen shots the user encounters when using the application on a mobile device, such as, for example, a smart phone or tablet. Referring initially to FIG. 1, the user launches the application at step 10 whereat the splash screen of FIG. 11 is displayed and tour screen shown in FIG. 32 appears to the user. After the tour, the application continues to step 12 whereat the user indicates whether it is the user's first use of the application or not. If the user clicks the “Yes” button, the user is taken to initial screen module 14 (see FIG. 12). In initial screen module 14, the user is given the opportunity to “sign up” using button 16, “sign in” using button 18, “connect with Facebook®” using button 20, or “connect with Twitter®” using button 22.

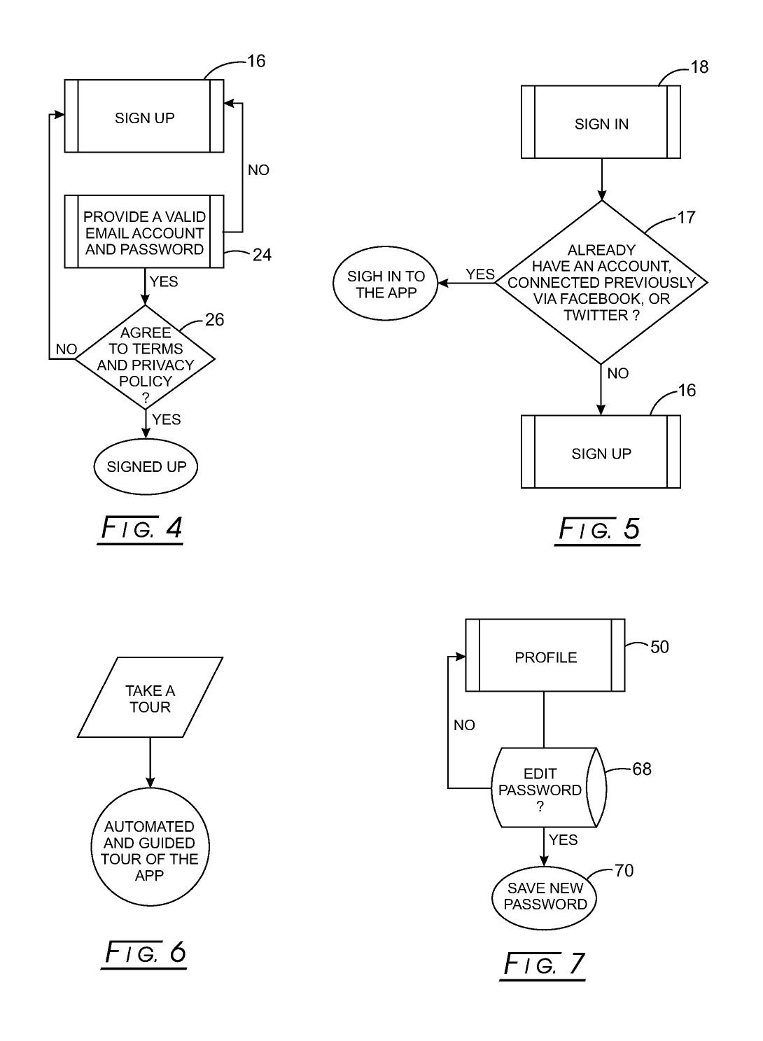

If this is a first use of the app by the user, the user will indicate such by clicking “Sign Up” button 16 whereupon the application proceed to step 24 in FIG. 4. The user is taken to the screen in FIG. 13, where the user is requested to provide a valid email account and password. If the user fails to provide this information, the user is taken back to initial screen module 14 and is not permitted to sign up. Once the user enters a valid email account and password, the app proceed to step 26 and the user sees the screen in FIG. 15 where the privacy policy is displayed and the user queried to agree to the terms and privacy policy. If the user does not agree, the user is taken back again to initial screen module 14 and not permitted to sign up for the app. If the user assents to the privacy policy, the user is taken to the screen in FIG. 14 where the terms and conditions of use of the app are displayed and the user is queried to agree thereto. If the user does not agree, the user is taken back again to initial screen module 14 and not permitted to sign up for the app. If the user assents to the terms and conditions, the user is signed up and the app proceeds to main menu 28 (see FIG. 34).

Returning to initial screen module 14, the user may hit button 20 to sign up for a Facebook® account. The app proceeds to step 30 where the user is queried as to whether the user has an existing Facebook® account. If the answer is no, then the app proceed to step 32 where the user is asked to create a Facebook® account and the app returns to initial screen module 14. If the answer is yes, then the app proceed to step 32 where the user is asked whether he/she has the Facebook® app installed on their mobile device. If the answer is no, the app proceeds to step 34 where the user is asked to install the Facebook® app on his/her mobile device and the app returns to step 30. If the user does have the Facebook® app already installed on his/her mobile device, the app proceeds to step 36 where the Facebook® app on the user's mobile device is activated and the Facebook® app opens.

Returning to initial screen module 14, the user may hit button 22 to sign up for a Twitter® account. The app proceeds to step 40 where the user is queried as to whether the user has an existing Twitter® account. If the answer is no, then the app proceed to step 42 where the user is asked to create a Twitter® account and the app returns to initial screen module 14. If the answer is yes, then the app proceed to step 44 where the user is asked whether he/she has the Twitter® app installed on their mobile device. If the answer is no, the app proceeds to step 46 where the user is asked to install the Twitter® app on his/her mobile device and the app returns to step 30. If the user does have the Twitter® app already installed on his/her mobile device, the app proceeds to step 48 where the Twitter® app on the user's mobile device is activated and the Twitter® app opens.

Returning to initial screen module 14, the user also can hit button 18 to sign in to the app. The user is queried whether he/she already has an account, connected previously via Facebook® or via Twitter®. If the user says no, they are taken to step 16 to sign up. If the user says yes, they are signed in to the app.

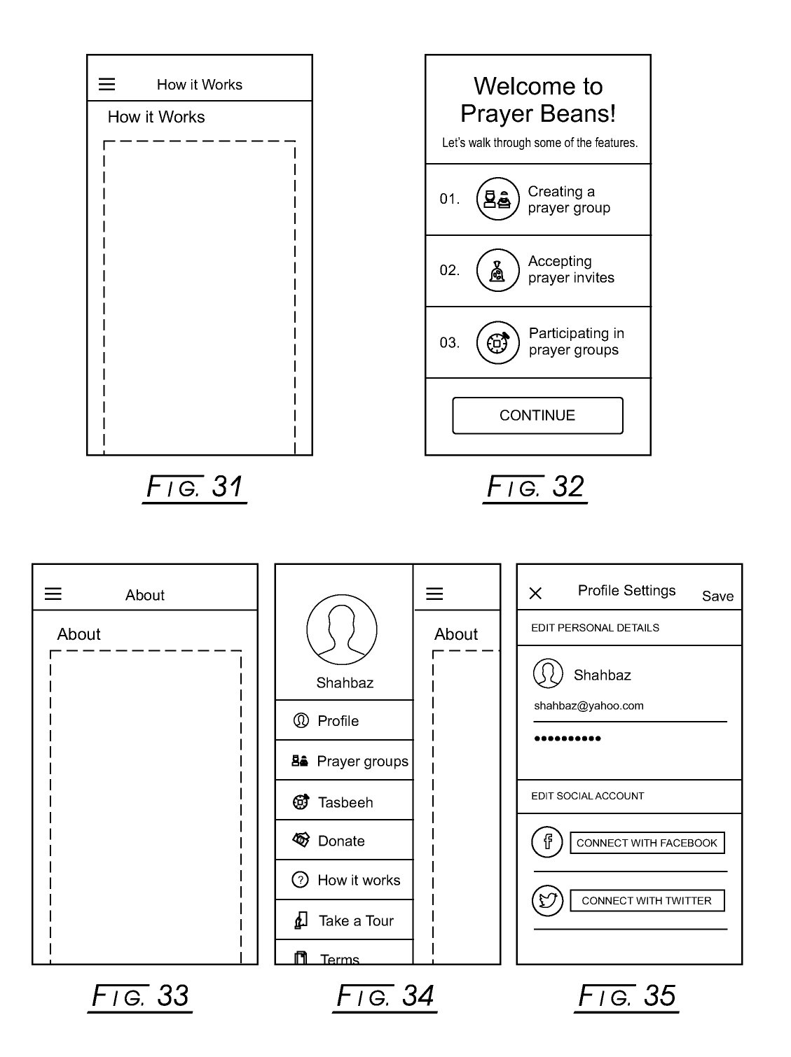

On main menu 28, the user is given the option to enter/edit the user's profile using button 50 whereupon the user is taken to the screen in FIG. 35; access prayer groups using button 52 whereupon the user is taken to the screen in FIG. 16; access Tasbeeh using button 54 whereupon the user is taken to the screen in FIG. 28; donate money whereupon the user is taken to the screen in FIG. 30; receive an explanation of how the app works using button 58 whereupon the user is taken to the screen in FIG. 31; take a tour of the app using button 60 whereupon the user is taken to the screen in FIG. 32; read the terms of use of the app using button 62 whereupon the user is taken to the screen in FIG. 14; read the privacy policy of the app using button 64 whereupon the user is taken to the screen in FIG. 15; and learn about the app using button 66 whereupon the user is taken to the screen in FIG. 33.

If the user clicks the profile button on main menu 28, the user is taken to the screen in FIG. 35 and the app proceeds to step 68 in FIG. 7 where the user is queried about editing his/her password. If the user says no, they are returned to main menu 28. If the user indicates a desire to change his/her password, the user enters the new password and the app proceed to step 70 where the new password is saved and the user returned to main menu 28. On the profile settings screen in FIG. 35, the user also is given the option to connect with Facebook® or Twitter® also.

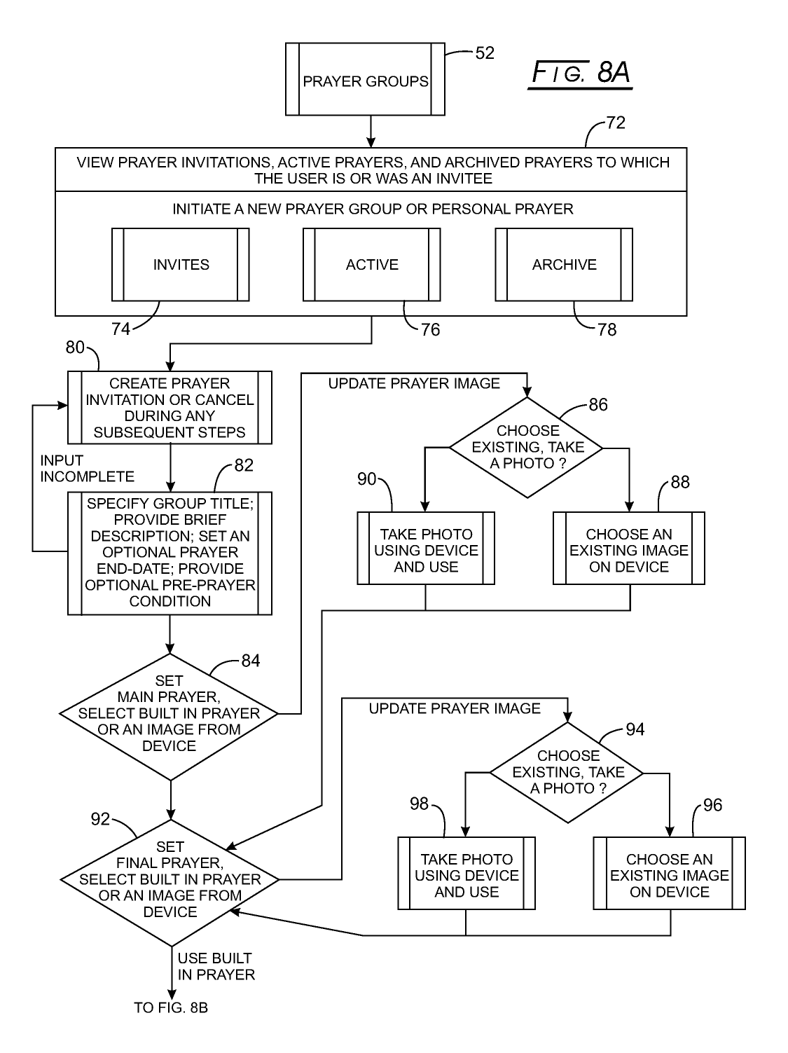

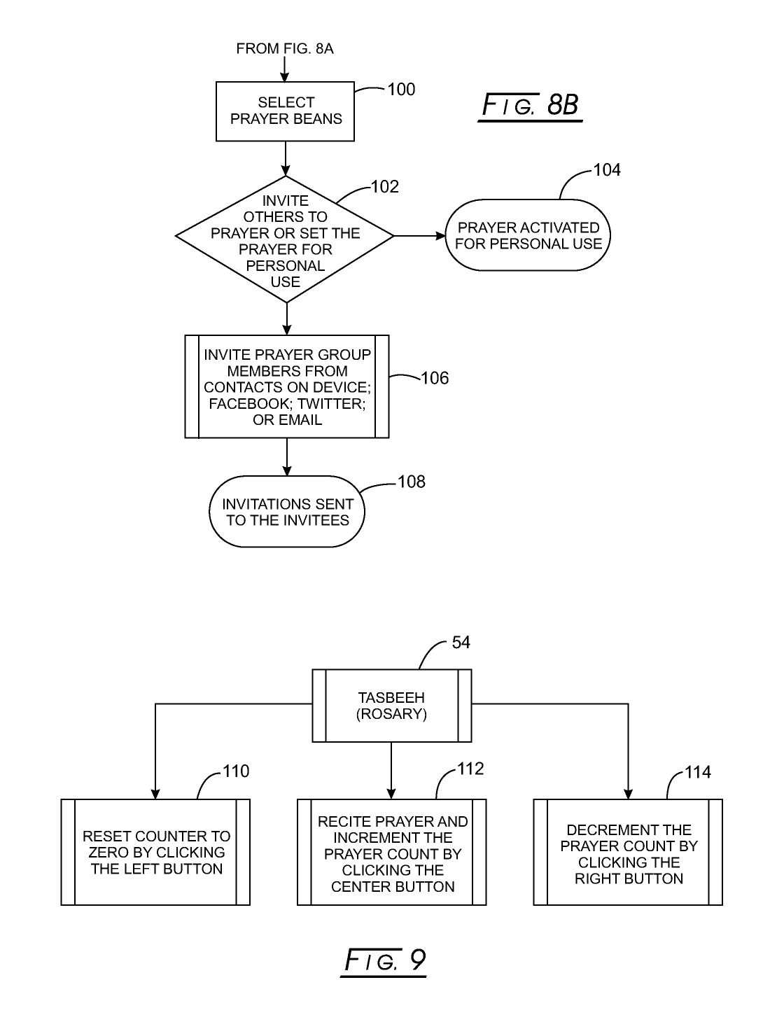

If the use clicks prayer groups button 52 on main menu 28, the app proceeds to step 72 as show in FIG. 8A where the user can view prayer invitations, view active prayers and view archived prayers to which the user is/was an invitee. In order to select one of these options, the user can hit one of the following label buttons: Invites 74, Active 76, and Archive 78. The user is viewing the screen in FIG. 16 where active prayers are displayed. If there are no active prayers, the user is invited to add a prayer by clicking the +button. When the + button is depressed, the app proceed to step 80 and the user is viewing the screen in FIG. 17 where a Main Prayer can be created. Such prayer can be a user created prayer or the user can select from a list of existing prayers in step 82. The user will be asked to specify a group title, provide a brief description of the prayer (i.e., a prayer for wellness), set an optional prayer end date, provide an optional pre-prayer condition. If any of the data is incomplete, the app returns the user to step 80.

In step 84, the user sets the Main Prayer from the screen in FIG. 17. The user can upload an image for the prayer in step 86 by choosing an existing image in step 88 or by taking a photo using the user's mobile device in step 90. The user also can create a Final Prayer in step 92 where the user is viewing the screen in FIG. 18. Again, the user can upload an image in steps 94, 96, and 98, as described above for the Main Prayer. If the user selects to upload an image, the app warns the user on the propriety and probity of the image, stating that disrespectful images are forbidden.

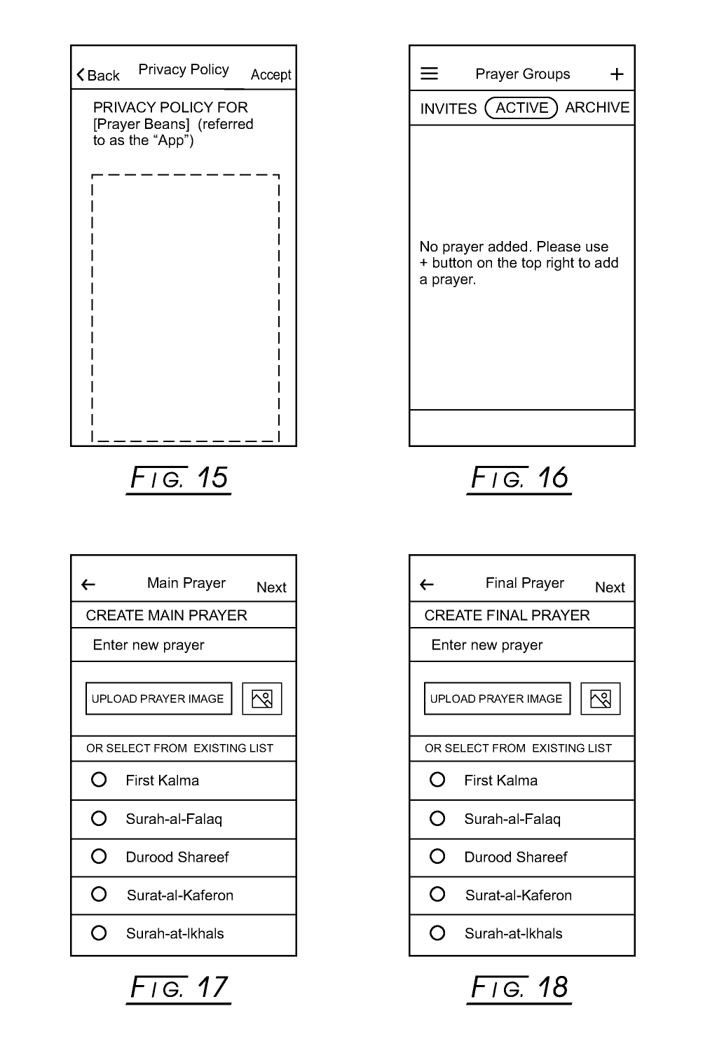

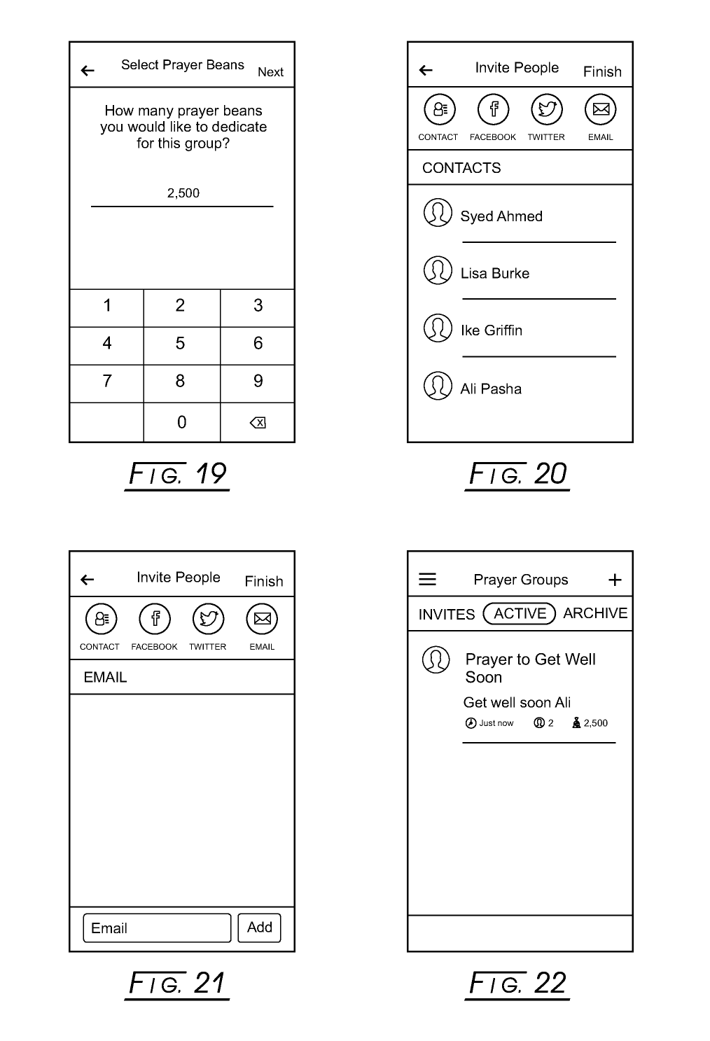

The app, then, proceed to step 100 in FIG. 8B where the user can select prayer beans with the user viewing the screen in FIG. 19. The user enters a numerical number on the keypad available on this screen. Once the number of prayer beans has been set by the user and the back arrow hit by the user, the app proceed to step 102 and the screen shown in FIG. 20. The user can invite others to pray or keep the prayer personal in step 104. The user can invite others using his/her contact list, Facebook®, Twitter®, or by email. Buttons are available on the screen for implementing the user's selection with the app being at step 106. Contacts are shown in FIG. 20 for illustration. The screen in FIG. 21 is where the user would send an email to invite another.

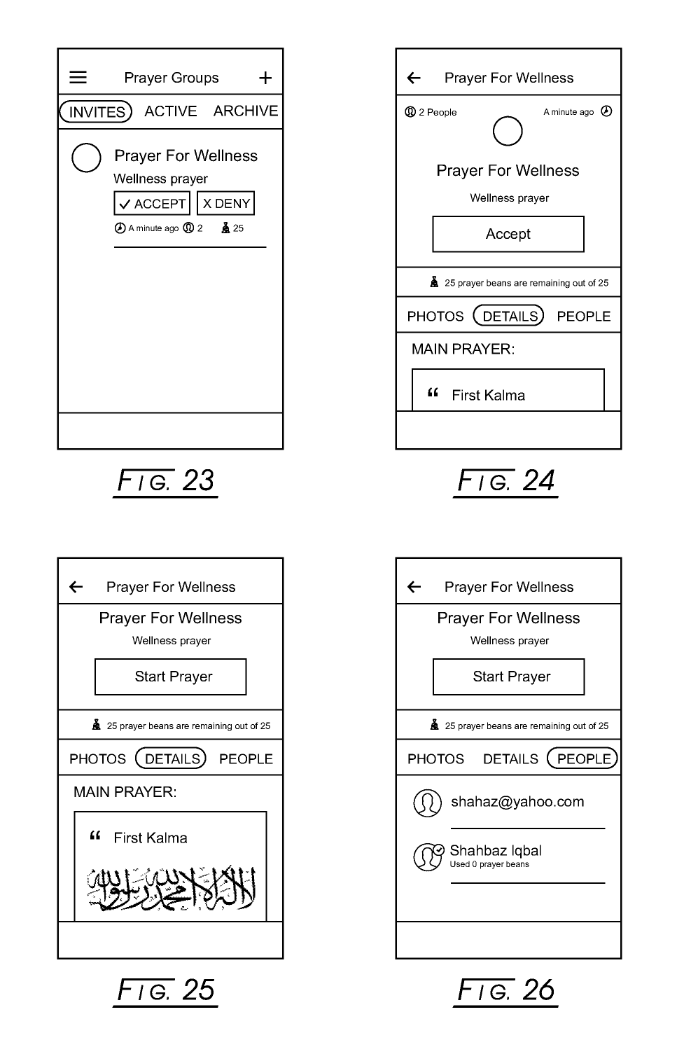

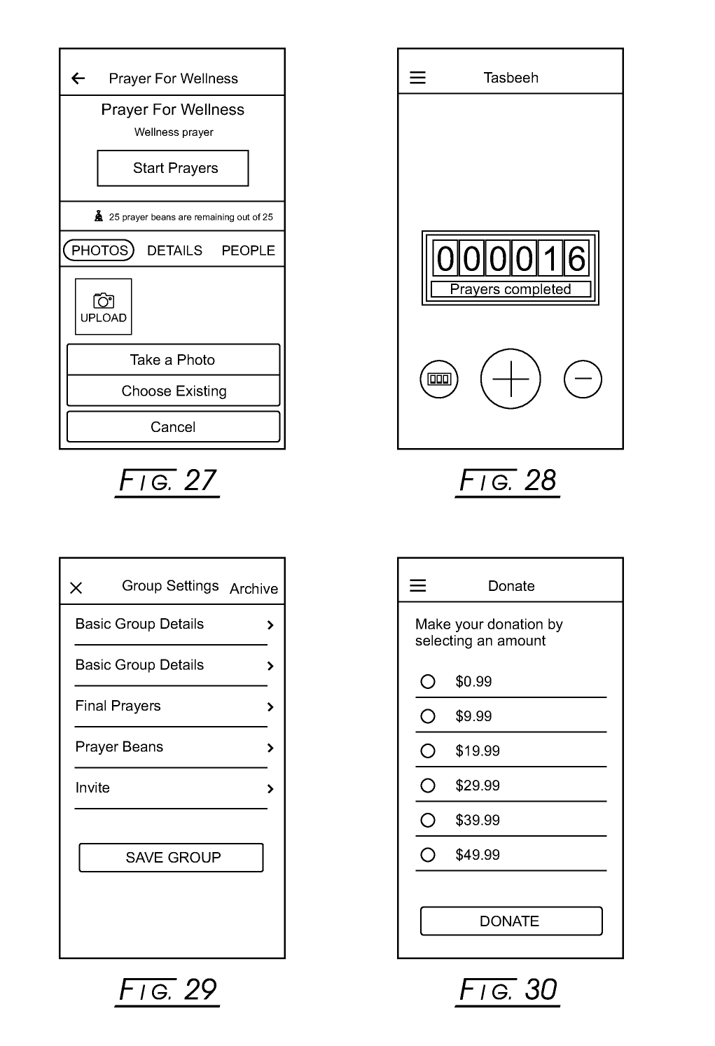

The screen in FIG. 22 shows an active prayer group for a get well prayer and what appears to the user when the “active” button is hit on this screen. The screen in FIG. 23 shows the user whether a prayer group request has been accepted or denied. The screen in FIG. 24 shows the details of the Main Prayer. By clicking the Accept button on this screen, the user will be able to start praying, as shown in the screen in FIG. 25. The screen in FIG. 26 shows the same screen when the user clicks the People button rather than the Details button in FIG. 25. Finally, the user will see the screen in FIG. 27 when the “Photos” button on this screen is hit. A summary of the Group Settings and the ability of the user archiving a prayer is shown in the screen of FIG. 29. It should be noted that the user also has the ability to override the prayer if it is not being completed on time or the prayer count is low and the user complete the prayer instead of the group.

Returning now to FIG. 1 and Main Menu 28, when the user clicks the “Tasbeeh” button, the app proceeds as shown in FIG. 9 and the user is taken to the screen shown in FIG. 28. Here, the user can reset the counter in step 110, increment the prayer counter after reciting a prayer in step 112, or decrement the counter in step 114.

Returning now to FIG. 1 and Main Menu 28, when the user clicks the “Donate” button, the app proceed as shown in FIGS. 10A and 10B. Referring initially to FIG. 10A, the user is taken to the screen shown in FIG. 30 and the app proceeds to step 116 where the user is able to select a pre-designated amount of money to donate by clicking one of the buttons beside the shown amounts of money. Once the amount of money has been selected, the user hits the “Donate” button and the app proceeds to step 118 where the user is queried as how to implement payment, viz., PayPal® or Credit/Debit Card. If the user elects to donate using his/her PayPal® account, the app proceeds to step 120 where the user is queried as to whether they have donated using PayPal® yet. If the answer is “yes”, the app proceed to step 122 where the user is asked to login to the Paypal® account using email and password. The app proceeds then to step 124 where the user is asked to select the “Preferred” account and then the “Send Payment” button. The app proceeds to step 126 where successful payment is acknowledged by clicking on the “OK” button, whereupon PayPal® becomes the default donation method for future payments.

Returning to step 120, if the user answers no to the use of PayPal® to donate in the past, the app proceed to step 128 where the user is asked whether they have an previously registered PayPal® account. If the user responds “no”, the app proceed to step 130 where the user can opt to pay by credit card, log out of donating, or use a new PayPal® account.

In case the user opts to donate using a credit card in either steps 120 or 130, the app proceed to step 132 in FIG. 10B where the user is asked if this is the first instance of use of the card to donate in the app. If the answer is “no”, the app proceeds to step 134 where the user is asked whether the user will be using a previously registered card. If the answer is “yes”, the app proceeds to step 136 where the user clicks on the “Charge Card” button. The app proceeds to step 138 where the user clicks the “OK” button to acknowledge successfully payment and the card becomes the default donation method of payment. In step 134, if the user answers “No”, the app proceed to step 140 where the user can click on the “Change Method of Payment” button and the card is cleared. The user, then, can opt to use a new card whereupon the app proceeds to step 142 or to use Paypal® whereupon the app proceeds to step 122.

Returning to step 132, if the user answers “Yes”, the app proceeds to step 142 where the user's mobile device will be used to take an image of the card by the user placing the credit card on a flat surface and bracketing the four corners of the card by the green four-corner guide. When the card is properly and fully bracketed, the app automatically takes the picture/image of the card. The app, then, proceeds to step 142 where the user enters the expiration date and Card Verification Value (CVV or CVV2) code of the card. The user then clicks the “Done” button on the next screen. The app proceeds to step 144 where the user clicks the “OK” button to acknowledge successfully payment and the card becomes the default donation method of payment.

Returning now to FIG. 1 and Main Menu 28, when the user clicks the “How it Works” button, the app takes the user to the screen shown in FIG. 31 where a description of the how the app works is given.

Returning now to FIG. 1 and Main Menu 28, when the user clicks the “Take a Tour” button, the app takes the user to the screen shown in FIG. 32 where a the app walks the user through several of the features of the app. When the user is finished with the tour, the user clicks the “Continue” button to return to main menu 28.

Returning now to FIG. 1 and Main Menu 28, the user also has the opportunity to click the “Terms”, “Privacy Policy”, and “About” buttons, which have been described above.

While the application and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. Also, all citations referred herein are expressly incorporated herein by reference.

I claim:

1. A method for conducting prayers using a mobile device, which comprises the steps of:
(a) presenting an interface enabling the user to designate a specific prayer or select from a stored prayer;
(b) presenting an interface enabling the user to select a number of prayer times that the designated prayer will be recited;
(c) presenting an interface enabling the user to initiate contact with one or more individuals by entering an email address, using the user's contacts, or the user's social media account in order to invite the one or more individuals to join a prayer group for the designated prayer;
(d) presenting an interface enabling the user initiate the prayer for the prayer group;
(e) presenting an interface enabling the user to count the number of times that the user has recited the designated prayer; and
(f) presenting an interface enabling the user to donate from a pre-determined list of denominations using an electronic payment account of the user.

2. The method of claim 1, wherein step (a) includes an interface enabling the user to create a main prayer and an interface enabling the user to create a final prayer.

3. The method of claim 1, further comprising the step of presenting an interface enabling the user to archive one or more a prayer group, prayers, prayer count, or invites.

4. The method of claim 1, further comprising the step of presenting an interface enabling the user can take a photo for display to the prayer group members.

5. The method of claim 1, further comprising the step of presenting an interface enabling the user to create and edit profile settings of the user.

6. The method of claim 1, further comprising the step of presenting an interface enabling the user to view a list of the members of a prayer group.

7. The method of claim 1, further comprising the step of presenting an interface enabling the user to specify a prayer group title, set an optional prayer end date, or provide an optional pre-prayer condition.

8. The method of claim 1, wherein step (e) includes an interface enabling the user to increment and decrement the number of times a prayer has been recited.

9. The method of claim 1, further comprising the step of presenting an interface enabling the user to override the prayer and the user complete the prayer instead of the group.
